(19) United States
(12) Patent Application Publication
(10) Pub. No.: US 2016/0042300 A1
(43) Pub. Date: Feb. 11, 2016

(54) SUPPORT OF MULTIPLE BOOKING PARTNER SPECIFICATIONS IN THE SAME FLIGHT AND TRAVEL SEARCH QUERY

(71) Applicant: Google Inc., Mountain View, CA (US)

(72) Inventors: Denis Chebikin, Bedford, MA (US); Todd A. Williamson, Brookline, MA (US)

(21) Appl. No.: 14/455,632

(22) Filed: Aug. 8, 2014

(51) Int. Cl. G06Q 10/02

(52) U.S. Cl. CPC G06Q 10/02

(57) ABSTRACT

Computer-implemented methods, software, and systems efficiently process a travel search query that includes multiple partner specifications. One computer-implemented method includes receiving a travel search query for a journey, retrieving multiple booking partner specifications associated with the received travel search query, retrieving other data applicable to the received travel search query from a data store, creating a computation record for each travel-search-query-associated computation determined to require data associated with a particular booking partner specification of the multiple booking partner specifications, for each computation record repeating the associated travel-search-query-associated computation for data similar to the required data associated with each applicable booking partner specification to generate fares, tagging each generated fare with the accessed data for which it is valid to generate tagged generated fares, and returning the tagged generated fares for use in generating a travel search query pricing solution in a response to the received travel search query.

### BACKGROUND

A travel planning system (TPS) typically works with many booking partners (e.g., airline websites and online travel agencies), and each booking partner has its own, typically different, partner specification. To avoid a prohibitive computational cost in sending multiple queries to cover each of the specifications established by the many booking partners associated with a TPS travel search query (e.g., a single query for each booking partner to get a full set of prices available for all the booking partners), TPS travel search queries often contain a single, “unified,” booking partner specification combining all of the booking partner specifications. However, the use of a booking partner specification including all of the booking partner specifications can lead to undesirable query results, including pricing errors, booking partner conflicts, missing available fares, and other undesirable query results.

### SUMMARY

The present disclosure relates to computer-implemented methods, software, and systems for efficiently processing a travel search query that includes multiple booking partner specifications. A travel search query for a journey is received and booking partner specifications associated with the received travel search query are retrieved. Other data applicable to the received travel search query is also retrieved from a data store. A computation record is created for each travel-search-query-associated computation determined to require data associated with a particular booking partner specification. For each computation record, the associated travel-search-query-associated computation is repeated for data similar to the required data associated with each applicable booking partner specification to generate fares. Each generated fare is tagged with the accessed data for which it is valid to generate tagged generated fares and the tagged generated fares are returned for use in generating a travel search query pricing solution.

The present disclosure relates to computer-implemented methods, software, and systems for efficiently processing a travel search query that includes multiple booking partner specifications. One computer-implemented method includes receiving a travel search query for a journey, retrieving, by a computer, multiple booking partner specifications associated with the received travel search query, retrieving, by a computer, other data applicable to the received travel search query from a data store, creating, by a computer, a computation record for each travel-search-query-associated computation determined to require data associated with a particular booking partner specification of the multiple booking partner specifications, for each computation record, by a computer, repeating the associated travel-search-query-associated computation for data similar to the required data associated with each applicable booking partner specification to generate fares, tagging, by a computer, each generated fare with the accessed data for which it is valid to generate tagged generated fares, and returning, by a computer, the tagged generated fares for use in generating a travel search query pricing solution in a response to the received travel search query.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

In a first aspect, combinable with the general implementation, wherein the other data applicable to the received travel search query includes one or more of air-carrier data, flight data, fare data, and an algorithm.

In a second aspect, combinable with the general implementation, wherein the accessed data associated with the booking partner specification is based upon an Airline Tariff Publishing Company (ATPCO) category rule.

A third aspect, combinable with any of the previous aspects, wherein generated fares are stored as a generated fare containing information about the circumstances under which a particular fare is used.

A fourth aspect, combinable with any of the previous aspects, wherein multiple generated fares are created for the same fare.

A fifth aspect, combinable with any of the previous aspects, wherein the tagged generated fares are used to generate priceable units as part of the travel search query pricing solution.

A sixth aspect, combinable with any of the previous aspects, comprising calculating taxes and other carrier-imposed surcharges using the required data associated with each applicable booking partner specification used to generate fares.

The subject matter described in this specification can be implemented in particular implementations so as to realize one or more of the following advantages. First, overall travel planning system travel search query efficiency is increased. A multi-partner query provides an alternative to performing multiple queries (e.g., one for each booking partner; which can introduce a prohibitive computational performance cost) or in other implementations using one artificially created “unified” booking partner query (combining multiple booking partners into a single booking partner) which can lead to undesirable query results including pricing errors, booking partner conflicts, missing available fares, and other undesirable query results. Although, in some implementations, a travel search query using a multi-partner query can have slightly longer query duration as compared with the use of the unified booking partner, a slightly increased query duration outweighs the disadvantages associated with the use of a unified booking partner query. Customers (e.g., travel agencies) with multiple sales channels can use the described subject matter to, for example, output the price of an airline trip for each sales channel, or the lowest price of a trip over all sales channels without incurring prohibitive computational cost. Second, travel search query accuracy is increased. For example, the use of the unified booking partner workaround can introduce undesirable query results including pricing errors, booking partner conflicts, missing available fares, and other undesirable query results. The ability to search over many booking partners using a limited number of queries helps to mitigate or eliminate these types of undesirable query results. Other advantages will be apparent to those skilled in the art.

The details of one or more implementations of the subject matter of this disclosure are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example travel planning system (TPS) for efficiently processing a travel search query that includes multiple booking partner specifications according to an implementation.

FIG. 2 is a flow chart illustrating a method to efficiently process a travel search query that includes multiple booking partner specifications according to an implementation.

Like reference numbers and designations in the various drawings indicate like elements.

### DETAILED DESCRIPTION

The following detailed description generally describes computer-implemented methods, computer-program products, and systems for efficiently processing a travel search query that includes multiple booking partner specifications and is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein. For example, although the following description is focused on airline travel search query, the described subject matter can also be applied to other forms of travel planning such as that involving automobiles, trains, watercraft, lodging, and/or other forms of travel planning.

At a high level, a booking partner specification provides information about a geographical location (e.g., a sales city) as well as a special code (e.g., typically the travel agency code or the sales carrier) identifying an agency or website selling an airline ticket. At a lower level, in a travel planning system (TPS) travel search query, a booking partner specification includes, but is not limited to, a booking channel, a tax compatibility mode—a set of certain tax application rules that can vary depending on which booking system the booking partner uses (e.g., some booking systems add a US International Arrival/Departure tax to trips between two points in the United States that involve international intermediate points, while other booking systems do not), a validating carrier, itinerary restrictions (e.g., a booking partner may wish not to sell itineraries that involve certain airlines), other configuration parameters that control answers returned by the travel planning system, and/or a point-of-sale (POS) specification, which, in some implementations, contains sales and ticketing location (city/country), account codes, travel agency and department codes, sales carrier, and sales computer reservation system (CRS). A tax compatibility mode ( )

In one example, rules associated with an airline fare often specify that the airline fare can be used only if a POS meets certain conditions. For example, a fare may require that the ticket is sold in the United States and that the booking partner specification include a particular special code (e.g., AB01). In other words, the set of airline fares considered by the TPS airfare query depends, at least in part, on a POS associated with a booking partner specification specified by the query.

A TPS typically works with many booking partners; each booking partner with a different associated booking partner specification. In some implementations, to avoid a prohibitive computational cost in sending multiple queries to cover each of the many booking partners associated with a TPS travel search query (e.g., a single query for each booking partner to get a full set of prices available for all the booking partners), TPS travel search queries can be configured to contain a single, “unified,” booking partner specification combining all of the special codes associated with applicable booking partner specifications, sales carriers, etc. However, the use of a unified booking partner specification in these implementations can lead to undesirable query results including pricing errors, booking partner conflicts, missing available fares, and other undesirable query results. For example, two airline fares that are each restricted to their own booking partner may appear together on the ticket. Another example involves airline fares whose rules (e.g., rule 120 below) contain “negative coding” (e.g., if one booking partner specification includes agency code “AAA,” another booking partner specification includes agency code “BBB,” and a certain airline fare requires that agency code “AAA” be present in the booking partner specification while agency code “BBB” NOT be present in the booking partner specification, then the airline fare will not work with a “unified” booking partner specification, although it is valid for one of the actual booking partners.

The following description details functionality associated with algorithms allowing handling of multiple booking partner specifications and annotation of each returned answer to the TPS travel search query with one or more POSs for which the answer is valid. Although the following description provides examples focused on the use of POS information as part of a POS specification, in other implementations, any data associated with a booking partner specification (e.g., booking channel, tax compatibility mode, validating carrier, etc.) can be used in a similar manner. The use of examples focused on POS data should not be used to limit the described subject matter to the use of POS data.

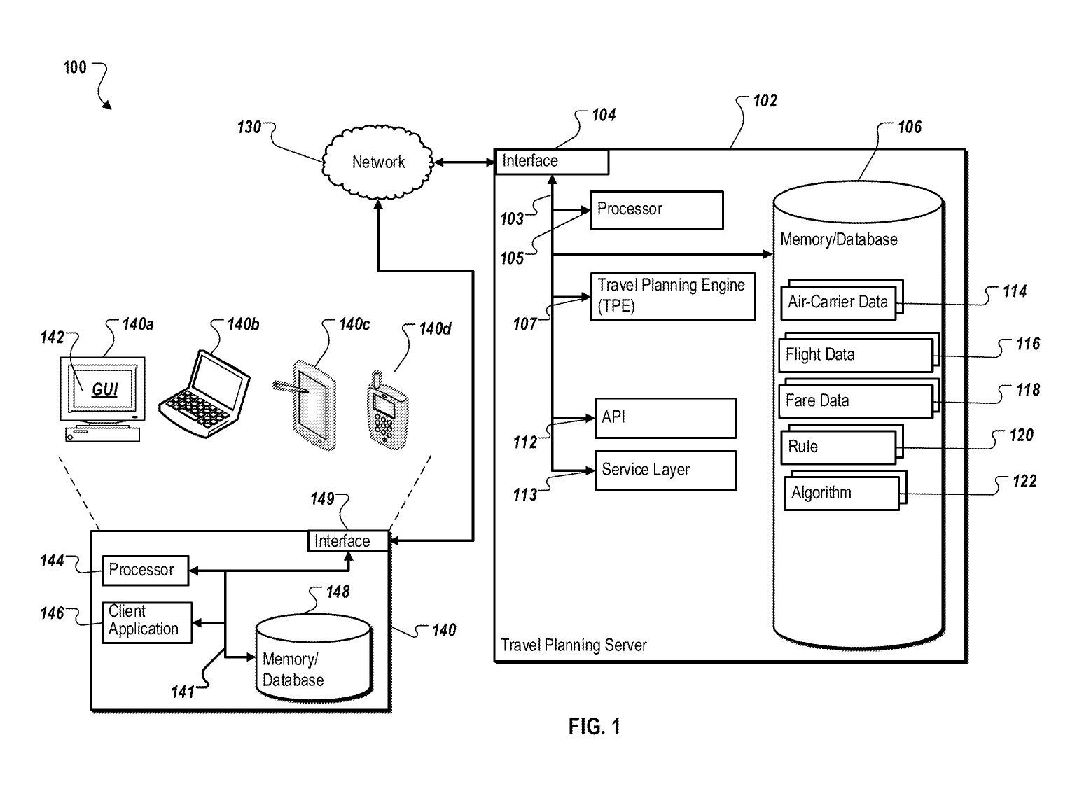

FIG. 1 is a block diagram illustrating an example travel planning system (TPS) 100 for efficiently processing a travel search query that includes multiple booking partner specifications. The illustrated TPS 100 includes, or is communicably coupled with, a travel planning server 102 and a client 140 communicating across a network 130. While FIG. 1 depicts a client-server environment, FIG. 1 could also represent a portion of a cloud-computing environment.

At a high level, the travel planning server 102 is an electronic computing device operable to receive, transmit, process, store, or manage data and information associated with the TPS 100. In some implementations, a travel-planning server 102 user, for example using a client 140, is provided with an efficient and user-friendly presentation of data provided by or communicated within the example TPS 100 (e.g., through a graphical user interface (GUI)).

In general, the travel planning server 102 provides functionality appropriate to a server, including database functionality and receiving/serving content and/or functionality from/to a client permitting, for example, efficiently processing a travel search query that includes multiple booking partner specifications as described herein. The travel planning server 102 is also responsible for receiving application requests from a client 140 (as well as any other entity or system interacting with the travel planning server 102), for example to processes a travel search query responding to the received requests by processing said requests in an associated TPE 107, and sending the appropriate responses from the TPE 107 back to the requesting client 140 and/or other requesting system. The TPE 107 can also process and respond to local requests from a user accessing the associated travel planning server 102. Accordingly, in addition to requests from the client 140, requests associated with a particular TPE 107 may also be sent from internal users, external or third-party customers, other applications, and/or any other appropriate entities, individuals, systems, or computers.

In alternative implementations, the elements illustrated within the travel planning server 102 and/or the client 140 may be included in or associated with different and/or additional servers, clients, networks, or locations other than those illustrated in FIG. 1. For example, according to some implementations, the travel planning server 102 may also include or be communicably coupled with an e-mail server, a web server, a caching server, a streaming data server, a business intelligence (BI) server, and/or other server. Additionally, the functionality associated with the travel planning server 102 may be associated with any suitable system, including by adding additional instructions, programs, applications, or other software to existing systems. For example, the components illustrated within the travel planning server 102 may be included in multiple servers, cloud-based networks, or other locations accessible to the travel planning server 102 (e.g., either directly or through network 130).

In some implementations, the travel planning server 102 can store and execute various other applications (not illustrated), while in other implementations, the travel planning server 102 may be a dedicated server meant to store and execute a particular TPE 107 and related functionality. In some implementations, the travel planning server 102 can contain a web server or be communicably coupled with a web server, where the particular TPE 107 associated with that travel planning server 102 represents a web-based (or web-accessible) application accessed and/or executed on an associated client 140 to perform the programmed tasks or operations of the corresponding TPE 107. In some implementations, the TPE 107 can execute functionality associated with other local, remotely networked, and/or cloud-based applications (not illustrated). In still other implementations, the TPE 107 may be executed on a first system, while the TPE 107 manipulates and/or provides information for data located at a remote, second system.

Each of the components of the travel planning server 102 can communicate using a system bus 103. In some implementations, any and/or all the components of the travel planning server 102, both hardware and/or software, may interface with each other and/or the interface 104 over the system bus 103 using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the TPS 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the travel planning server 102 in the TPS 100, alternative implementations may illustrate the API 112 and/or the service layer 113 as stand-alone components in relation to other components of the TPS 100. Moreover, any or all parts of the API 112 and/or the service layer 113 may be implemented as child or sub-modules of another software module, enterprise application, or hardware module without departing from the scope of this disclosure. For example, the API 112 could be integrated into the database 106, the server application 107, and/or wholly or partially in other components of server 102 (whether or not illustrated).

The travel planning server 102 includes an interface 104. Although illustrated as a single interface 104 in FIG. 1, two or more interfaces 104 may be used according to particular needs, desires, or particular implementations of the TPS 100. The interface 104 is used by the travel planning server 102 for communicating with other systems in a distributed environment—including within the TPS 100—connected to the network 130; for example, the client 140 as well as other systems communicably coupled to the network 130 (whether illustrated or not). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated TPS 100.

The travel planning server 102 includes a processor 105. Although illustrated as a single processor 105 in FIG. 1, two or more processors may be used according to particular needs, desires, or particular implementations of the TPS 100. Generally, the processor 105 executes instructions and manipulates data to perform the operations of the server 102. Specifically, the processor 105 executes the functionality required for efficiently processing a travel search query that includes multiple booking partner specifications.

Generally, the travel planning server 102 may be communicably coupled with a network 130 that facilitates communications between the components of the example TPS 100 (e.g., between the travel planning server 102 and the at least one client 140), as well as with any other local or remote computer, such as additional clients, servers, or other devices communicably coupled to network 130, including those not illustrated in FIG. 1. In the illustrated example travel planning system 100, the network 130 is depicted as a single network, but may be comprised of more than one network without departing from the scope of this disclosure, so long as at least a part of the network 130 may facilitate communications between senders and recipients. The network 130, however, is not a required component in some implementations of the present disclosure.

The travel planning server 102 also includes a memory 106 (e.g., a database) that holds data for the travel planning server 102. Although illustrated as a single memory 106 in FIG. 1, two or more memories may be used according to particular needs, desires, or particular implementations of the example TPS 100. While memory 106 is illustrated as an integral component of the travel planning server 102, in alternative implementations, memory 106 can be external to the travel planning server 102 and/or the example TPS 100. In some implementations, the memory 106 can be configured to store one or more instances of air-carrier data 114, schedule data 116, fare data 118, a rule 120, an algorithm 122, and/or other data.

In some implementations, air-carrier data 114 represents an air carrier name, address, identification number, abbreviation, countries of service, airport hub, or any other suitable data with respect to an air carrier. For example, a particular air carrier may have data stored in the at least one air-carrier data 114 instance as the name “Airborne Airlines”, address “1234 Airport Row, Flight City, MA 75001”, identification number “3170”, abbreviation “AA”, countries of service “US and UK”, and airport hub “BOS.” Other representations and types of air-carrier data may be used and/or stored without departing from the scope of the disclosure.

Flight data 116 instance may store information about one or more flights. For example, data for a flight may be represented as “AA flight 101 BOS-LHR.” In this example, a flight 101 on carrier AA from Boston, Mass. USA (BOS) to London Heathrow Airport, UK (LHR) The example flight data 118 illustrated in this disclosure is to be considered representative only, and one of ordinary skill will appreciate that in other implementations, the flight data 116 may be represented in numerous other ways without departing from the scope of the disclosure.

The flight/fare data 118 represents price data and/or conditions used to determine a fare associated with one or more flights segments. In some implementations, fare data 118 may also include, for example, air carriers, origin/destination endpoints, conditions for application of the fare, or other suitable data associated with the fare. The example fare data 118 illustrated in this disclosure is to be considered representative only, and one of ordinary skill will appreciate that in other implementations, the fare data may be represented in numerous other ways without departing from the scope of the disclosure.

Algorithm 122 may represent an engine (e.g., an algorithmic software engine) including one or more conditions, parameters, variables, instructions, constraints, references, and any other appropriate information for processing a received travel search query. For example, the algorithm 122, among other things, can analyze, using rule(s) 120 the query to determine the most efficient manner of processing a travel search query that includes multiple booking partner specifications. The rule(s) 120 can, in some implementations, identify various kinds of restrictive information regarding a fare. For example, the rule(s) 120 can be relevant to a POS (e.g., an Airline Tariff Publishing Company (ATPCO) Category 15 (“security”) rule, Category 12 (“surcharges”) rule, and/or other rule) and/or other aspect of a booking partner specification. In some implementations, the rule(s) 120 can be incorporated as part of the air-carrier data 114, flight data 116, fare data 118, the algorithm 122, and/or other data.

A travel planning engine (TPE) 107 is illustrated within the travel planning server 102. Although illustrated as a single TPE 107, two or more TPEs 107 may be used with the travel planning server 102 according to particular needs, desires, or particular implementations of the specific environment. The TPE 107 can be any application, program, module, process, or other software that may provide methods for efficiently processing a travel search query that includes multiple booking partner specifications. In some implementations, the TPE 107 can access, process, and/or modify air-carrier data 114, flight data 116, fare data 118, rule 120, algorithm 122, booking partner specification 126, and/or other data. In some implementations, a particular TPE 107 can operate in response to and in connection with at least one request received from a client 140. Additionally, a particular TPE 107 may operate in response to and in connection with at least one request received from other TPEs 107, including TPEs 107 associated with other travel planning servers 102. In some implementations, each TPE 107 can represent a web-based application accessed and executed by one or more remote clients 140 across the network 130 (e.g., through the Internet, or using at least one cloud-based service associated with the TPE 107). For example, part of a particular TPE 107 may be a web-based service associated with a TPE 107 that is remotely called, while another part of the particular TPE 107 may be an interface object or agent bundled for processing at a remote client 140. Moreover, any or all of a particular TPE 107 may be a child or sub-module of another software module or enterprise application (not illustrated). Still further, parts of the particular TPE 107 may be executed or accessed by a user working directly at the travel planning server 102, as well as remotely at a corresponding client 140. In some implementations, the air-carrier data 114, flight data 116, fare data 118, rule 120, algorithm 122, and/or other data can be defined with and/or stored within the TPE 107 as opposed to memory/database 106.

The client 140 may be any computing device operable to connect to and/or communicate with at least the travel planning server 102 using the network 130. In general, the client 140 comprises an electronic computing device operable to receive, transmit, process, and store any appropriate data associated with the TPS 100, for example, the TPE 107. More particularly, among other things, the client 140 can collect and transmit/upload content to the server 102 for integration/processing into/by the TPE 107. The client typically includes a processor 144, a client application 146, a memory/database 148, and/or an interface 149 interfacing over a system bus 141.

The client application 146 is any type of application that allows the client 140 to navigate to/from, request, view, create, edit, delete, administer, and/or manipulate content associated with the travel planning server 102 and/or the client 140. For example, the client application 146 can present GUI displays and associated data to a user that are generated/transmitted by the travel planning server 102 (e.g., the TPE 107 and/or memory/database 106) to allow a user to efficiently process a travel search query that includes multiple booking partner specifications, accept user input, and transmit the user input back to the travel planning server 102 for dissemination to the appropriate components of travel planning server 102, in particular the TPE 107 and/or the memory/database 106. In some implementations, the client application 146 can use parameters, metadata, and other information received at launch to access a particular set of data from the travel planning server 102 and/or other components of the TPS 100. Once a particular client application 146 is launched, a user may interactively process a task, event, or other information associated with the travel planning server 102 and/or other components of the TPS 100. For example, the client application 146 can generate and transmit a particular database request/query to the travel planning server 102.

In some implementations, the client application 146 can also be used perform administrative functions related to the TPE 107, memory/database 106, and/or the travel planning server 102 in general. For example, the TPE 107 can generate and/or transmit administrative pages to the client application 146 based on a particular user login, request, etc. to allow updating of algorithms 120, and/or other data on the travel planning server 102.

Further, although illustrated as a single client application 146, the client application 146 may be implemented as multiple client applications in the client 140. For example, there may be a native client application and a web-based (e.g., HTML) client application depending upon the particular needs of the client 140 and/or the TPS 100.

The interface 149 is used by the client 140 for communicating with other computing systems in a distributed computing system environment, including within the TPS 100, using network 130. For example, the client 140 uses the interface to communicate with a travel planning server 102 as well as other systems (not illustrated) that can be communicably coupled to the network 130. The interface 149 may be consistent with the above-described interface 104 of the travel planning server 102. The processor 144 may be consistent with the above-described processor 105 of the travel planning server 102. Specifically, the processor 144 executes instructions and manipulates data to perform the operations of the client 140, including the functionality required to send requests to the travel planning server 102 and to receive and process responses from the travel planning server 102.

The memory/database 148 typically stores objects and/or data associated with the purposes of the client 140 but may also be consistent with the above-described database 106 and/or memory/database 106 of the travel planning server 102 or other memories within the TPS 100 and be used to store data similar to that stored in the other memories of the TPS 100 for purposes such as backup, caching, and the like. Although illustrated as a combined memory/database, in some implementations, the memory and database can be separated.

Further, the illustrated client 140 includes a GUI 142 that interfaces with at least a portion of the TPS 100 for any suitable purpose. For example, the GUI 142 (illustrated as associated with client 140a) may be used to view data associated with the client 140, the travel planning server 102, or any other component of the TPS 100. In particular, in some implementations, the client application 146 may render GUI interfaces received from the TPE 107 and/or data retrieved from any element of the TPS 100.

There may be any number of clients 140 associated with, or external to, the TPS 100. For example, while the illustrated TPS 100 includes one client 140 communicably coupled to the travel planning server 102 using network 130, alternative implementations of the TPS 100 may include any number of clients 140 suitable to the purposes of the TPS 100. Additionally, there may also be one or more additional clients 140 external to the illustrated portion of the TPS 100 that are capable of interacting with the TPS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (example configurations illustrated as 140a-140d) is intended to encompass any computing device such as a desktop computer/server, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142 (illustrated by way of example only with respect to the client 140a).

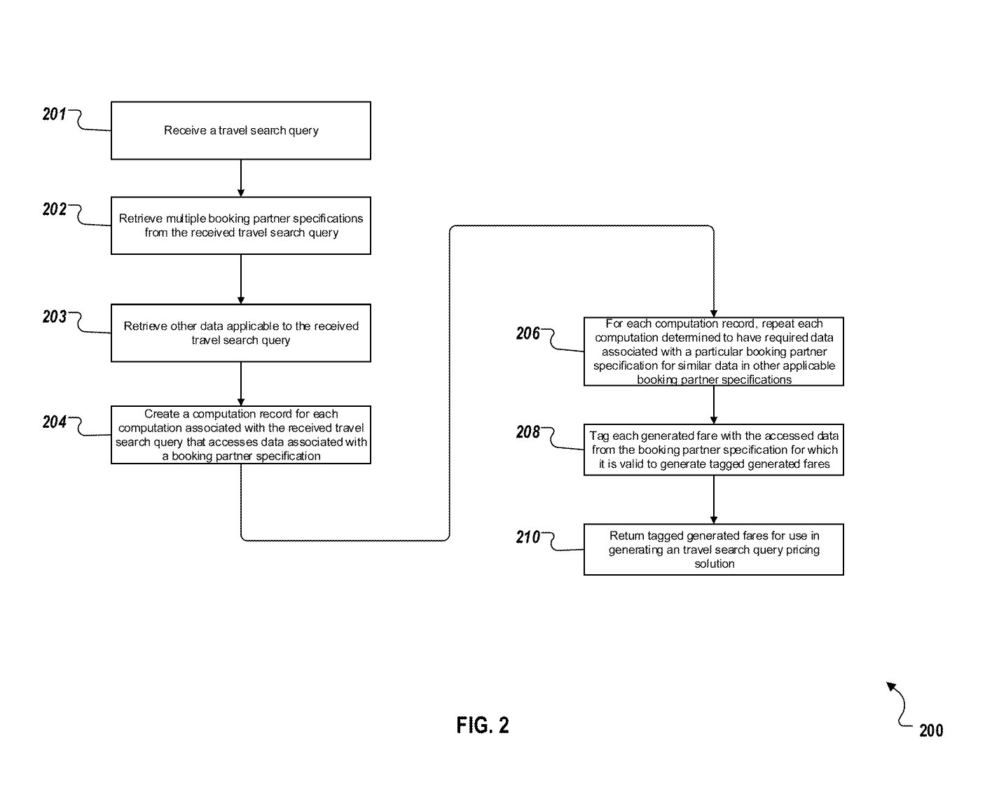

FIG. 2 is a flow chart illustrating a method 200 to efficiently process a travel search query that includes multiple booking partner specifications according to an implementation. For clarity of presentation, the description that follows generally describes method 200 in the context of FIG. 1. However, it will be understood that method 200 may be performed, for example, by any other suitable system, environment, software, and hardware, or a combination of systems, environments, software, and hardware as appropriate. Example data referred to in the description of method 200 is for representative purposes only and is not meant to limit the disclosure in any way.

At a high level, for each travel search query computation related to a fare or to a rule that requires knowledge of a data associated with a booking partner specification, the algorithm records the fact that the travel search query computation has looked up booking partner specification data. The algorithm then causes the computation to be repeated for each of the booking partner specifications in the query (e.g., if the booking partner specification data was POS data, the computation would be repeated for each POS associated with the multiple booking partner specifications associated with the travel search query). The algorithm then tags each of the obtained computational results with an index of the particular booking partner specification data associated with the computation. In this way, certain objects used by the TPS 100 to represent fares are tagged with a set of partner specification data (e.g., particular POSs) for which that fare is valid. Note that the following description of method 200 provides an example of a query computation related to a fare or to a rule that requires knowledge of POS data from the partner specification. As previously mentioned, in other implementations, any data associated with a booking partner specification (e.g., booking channel, tax compatibility mode, validating carrier, etc.) can be used in a similar manner. The use of examples focused on POS data should not be used to limit the described subject matter POS data.

At 201, a travel search query is received. For example, a travel search query can be received by the TPS from a client device. The received travel search query can be analyzed to determine how to proceed with processing of the query. From 201, method 200 proceeds to 202.

At 202 a booking partner specification is retrieved from the received travel search query. The booking partner specification includes a point-of-sale (POS) specification including a point-of-sale. From 202, method 200 proceeds to 203.

At 203, other data applicable to the received travel search query is retrieved from a data store (e.g., a memory/database containing air-carrier data 114, flight data 116, fare data 118, rule 120, algorithm 122, and/or other data).

For example, suppose the received travel search query is for a Boston→London→Boston airline round trip and is performed with two booking partner specifications including the following POSs:

POS#1: sales carrier AA, sales country US (United States)

POS#2: sales carrier BA, sales country GB (Great Britain)

In retrieving data from the data store, it is discovered that the options for the outbound and the return portions of the trip include the following flights:

AA flight 101 BOS-LHR

AA flight 102 BOS-LHR

BA flight 201 LHR-BOS

BA flight 202 LHR-BOS

The fares filed by carriers AA and BA that can cover the above flights are determined to include:

AA fare Q1, $500, available for flight AA101

AA fare H1, $600, available for flights AA101 and AA102

BA fare V2, $800, available for flight BA202

BA fare X2, $1000, available for flights BA201 and BA202

The above-mentioned fares are determined to have the following rules (e.g., rule(s) 120) that are relevant to a POS:

AA fare Q1: sales carrier must be AA

AA fare H1: surcharge of $150 if sold outside the US

BA fare V2: sales carrier must be BA

BA fare X2: no POS restrictions.

From 203, method 200 proceeds to 204.

At 204, a computation record is created of each computation associated with the received travel search query determined to have accessed POS data from a booking partner specification. Note that in this example, it is assumed that to evaluate the rules of the four fares above (AA fare Q1, AA fare H1, BA fare V2, and BA fare X2), the computations that would need to be repeated for each POS associated with the two received booking partner specifications are an application of an ATPCO Category 15 (“security”) rule applicable to fares Q1 and V2, and an application of an ATPCO Category 12 (“surcharges”) rule applicable to fare H1. These example computations/rules are to be considered representative only for purposes of this example, and one of ordinary skill will appreciate that in other implementations, various computations and/or rules, including other, less, or more computations and/or rules) may be considered as applicable to accessing POS data (or, in some implementations, other data associated with a booking partner specification) without departing from the scope of the disclosure. It should also be noted that since each fare typically has applicable rules in multiple categories, many of which are not related to POS, the amount of computation that will be repeated for each POS in a multi-booking partner travel search query remains small compared to repeating an application for all applicable fare rules (e.g., in some implementations, less than the computational cost that two separate single-POS travel search queries incur). From 204, method 200 proceeds to 206.

At 206, for each computation record of 204, the computation associated with the record is repeated for each POS associated with the booking partner specifications in the travel search query to generate fares. In some implementations, the computation is repeated for each POS as soon as a determination is made that a computation has accessed POS data associated with a booking partner specification. In other implementations, the repeating of the computation can take place at a later point in time, either for all or some point-of-sale data.

In some implementations, a generated fare (“GF”) is an internal data object/structure of any suitable type (e.g., an array, linked list, and/or other data object/structure) created by the TPS to represent a fare. Each GF contains information about the circumstances under which a particular fare is used, and sometimes multiple GFs are created for the same fare. For example, application of the above fare rules in a multiple-POS mode would result in the following generated fares:

GF#1 AA fare Q1, $500

GF#2 AA fare H1, $600

GF#3 AA fare H1, $750

GF#4 BA fare V2, $800

GF#5 BA fare X2, $1000.

From 206, method 200 proceeds to 208.

At 208, each generated GF is tagged with a point(s) of sale for which it is valid to generate a tagged fare. For example:

GF#1 AA fare Q1, $500, valid for POS#1

GF#2 AA fare H1, $600, valid for POS#1

GF#3 AA fare H1, $750, valid for POS#2

GF#4 BA fare V2, $800, valid for POS#2

GF#5 BA fare X2, $1000, valid for POS#1-2.

Note that in this example, the trip requires at least two different fares, one for the outbound and one for the return portion of the trip. In producing any such combination of two fares, it is required that each combination have at least one common POS (or, in other implementations, some other common data associated with a booking partner specification)—meaning at least one booking partner can sell both an outbound and inbound portion of an airline trip. This is relevant for the algorithm (e.g., algorithm 122) that can also be used to build “priceable units” (e.g., an airline industry term for a group of fares that (usually) can be sold together as a single ticket but that may not necessarily be available for sale individually (e.g., a so called “half-round-trip” fare cannot be sold on its own but must be paired with at least one other fare in a priceable unit)) as well as for the algorithm that puts together complete pricing solutions. As a concrete example, GF#1 and GF#4 cannot be used together as they share no common POS (e.g., GF#1 is only valid for an AA website and GF#4 is only valid for a BA website). Construction of priceable units from fare components is disclosed in issued U.S. Pat. No. 6,609,098, titled “Pricing Graph Representation for Sets of Pricing Solutions for Travel Planning System,” the entire disclosure of which is hereby incorporated by reference.

If there were no POS restrictions, the combination of flights AA101+BA202 would allow using any of the 3 GFs (e.g., GF#1, 2, or 3 for the outbound flight and any of the two GFs GF#4 or 5 for the return flight. TPS 100 would represent the set of possible GF combinations for this pair of flights as a simple Cartesian product:

(GF#1, GF#2, GF#3)×(GF#4, GF#5).

With the POS restrictions described above, the common POS requirement would limit the allowed GF combinations to:

| | GF#1 | GF#2 | GF#3 |
|---|---|---|---|
| GF#4 | | | + |
| GF#5 | + | + | + |

generated as a result of a pair of Cartesian products:

(GF#1, GF#2, GF#3)×(GF#5) and (GF#3)×(GF#4).

From 208, method 200 proceeds to 210.

At 210, the tagged fares are returned in a response to the received travel search query for use in generating a travel search query pricing solution. After 210, method 200 stops.

In some implementations, similar to the application of above-described POS-dependent fare rules, taxes and other carrier-imposed surcharges (e.g., “fuel and insurance surcharges”) that depend on a POS (or other data associated with a booking partner specification) can be efficiently computed. For a POS example, whenever a tax or surcharge computation needs to access/know POS data, the computation accesses the POS data using a data structure similar to an enhanced computation record (see FIG. 2, item 204) (e.g., a “POS set tracker (POSST)” with features for handling at least taxes and other carrier-imposed surcharges). A POSST records not only the fact that a POS access has been performed, but also which piece of POS data has been accessed. For example, if a certain tax depends on whether or not ticketing takes place in Canada and doesn't depend on POS in any other way, then the corresponding note will be made on the POSST that a required ticketing location was accessed and that it was Canada. At the end of computation (here the certain tax), POSST set can be used to examine the POS data properties that were accessed and to mark a result as valid for all points-of-sale that share these properties. The computation is then repeated for the remaining POS (similar to that describe above with respect to POS-dependent fares).

In the above-mentioned example, if “ticketing in Canada” was the only POS property that impacted the result of the certain tax computation, then that result (i.e., the certain tax that got computed) will be marked as valid for all points-of-sale specifying Canada as the country of ticketing, and then the computation will be repeated once for all the points-of-sale with ticketing outside of Canada (if there are such additional points-of-sale included the travel search query). In this way, the computation will be performed only twice in total instead of once for every POS.

Consider the following example. Suppose a travel search query for an airline trip from Montreal, Canada to Paris, France is performed with the following points-of-sale:

POS#1: ticketing in Montreal, account code AA01

POS#2: ticketing in Montreal, sales carrier AC

POS#3: ticketing in Paris, sales carrier AF

POS#4: ticketing in Paris, sales travel agency code STA4

POS#5: ticketing in Paris, sales travel agency code STA5

Suppose that the taxes potentially relevant to this trip include the following:

CAA tax: $10, applies to all trips ticketed in Canada

FRA tax: $20, applies to all trips ticketed in France

CAB tax: $15, applies to all trips originating in Canada

For each of these three taxes, a computation will be performed to evaluate the applicable tax amount, if any, using the POSST. For the CAA tax, the computation will begin by using POS#1 as the “current POS” and POS#1-#5 as the “current POS set”. Once the computation reaches the point at which ticketing location is checked, the POS set tracker will note that the current computation is valid for all POS which have the same ticketing country (Canada) as the current POS (#1), and it will reduce the current POS set to those POS (POS#1-#2). At the end of the CAA tax computation, the result will be marked as valid for POS#1-#2. The code will then repeat the computation using the remaining POS (#3-#5) as the current POS set and one of the remaining POS (e.g., POS#3) as the current POS. In this example, the result (e.g., “no tax”) will be marked as valid for POS#3-#5.

Consider the following additional example. Suppose a travel search query for an airline trip from Montreal, Canada to Paris, France is performed with the prior points-of-sale. Once the FRA and CAB taxes are computed in a similar manner, the results will look like this:

CAA tax, $10, POS#1-2

FRA tax, $20, POS#3-5

CAB tax, $15, POS#1-5

Overall, the CAA and the FRA tax computation will each be performed twice, and the CAB tax computation will be performed once, as the CAB tax does not depend on POS (based on origination in Canada).

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
receiving a travel search query for a journey;
retrieving, by a computer, multiple booking partner specifications associated with the received travel search query;
retrieving, by a computer, other data applicable to the received travel search query from a data store;
creating, by a computer, a computation record for each travel-search-query-associated computation determined to require data associated with a particular booking partner specification of the multiple booking partner specifications;
for each computation record, by a computer, repeating the associated travel-search-query-associated computation for data similar to the required data associated with each applicable booking partner specification to generate fares;
tagging, by a computer, each generated fare with the accessed data for which it is valid to generate tagged generated fares; and
returning, by a computer, the tagged generated fares for use in generating a travel search query pricing solution in a response to the received travel search query.

2. The computer-implemented method of claim 1, wherein the other data applicable to the received travel search query includes one or more of air-carrier data, flight data, fare data, and an algorithm.

3. The computer-implemented method of claim 1, wherein the accessed data associated with the booking partner specification is based upon an Airline Tariff Publishing Company (ATPCO) category rule.

4. The computer-implemented method of claim 1, wherein generated fares are stored as a generated fare containing information about the circumstances under which a particular fare is used.

5. The computer-implemented method of claim 4, wherein multiple generated fares are created for the same fare.

6. The computer-implemented method of claim 1, wherein the tagged generated fares are used to generate priceable units as part of the travel search query pricing solution.

7. The computer-implemented method of claim 1, comprising calculating taxes and other carrier-imposed surcharges using the required data associated with each applicable booking partner specification used to generate fares.

8. A non-transitory, computer-readable medium storing computer-readable instructions executable by a computer and configured to:
receive a travel search query for a journey;
retrieve multiple booking partner specifications associated with the received travel search query;
retrieve other data applicable to the received travel search query from a data store;
create a computation record for each travel-search-query-associated computation determined to require data associated with a particular booking partner specification of the multiple booking partner specifications;
for each computation record, repeat the associated travel-search-query-associated computation for data similar to the required data associated with each applicable booking partner specification to generate fares;
tag each generated fare with the accessed data for which it is valid to generate tagged generated fares; and
return the tagged generated fares for use in generating a travel search query pricing solution in a response to the received travel search query.

9. The computer-implemented medium of claim 8, wherein the other data applicable to the received travel search query includes one or more of air-carrier data, flight data, fare data, and an algorithm.

10. The computer-implemented medium of claim 8, wherein the accessed data associated with the booking partner specification is based upon an Airline Tariff Publishing Company (ATPCO) category rule.

11. The computer-implemented medium of claim 8, wherein generated fares are stored as a generated fare containing information about the circumstances under which a particular fare is used.

12. The computer-implemented medium of claim 11, wherein multiple generated fares are created for the same fare.

13. The computer-implemented medium of claim 8, wherein the tagged generated fares are used to generate priceable units as part of the travel search query pricing solution.

14. The computer-implemented medium of claim 8, comprising instructions configured to calculate taxes and other carrier-imposed surcharges using the required data associated with each applicable booking partner specification used to generate fares.

15. A computer system, comprising:
A memory; and
at least one hardware processor interoperably coupled to the memory and operable to:
receive a travel search query for a journey;
retrieve multiple booking partner specifications associated with the received travel search query;
retrieve other data applicable to the received travel search query from a data store;
create a computation record for each travel-search-query-associated computation determined to require data associated with a particular booking partner specification of the multiple booking partner specifications;
for each computation record, repeat the associated travel-search-query-associated computation for data similar to the required data associated with each applicable booking partner specification to generate fares;
tag each generated fare with the accessed data for which it is valid to generate tagged generated fares; and
return the tagged generated fares for use in generating a travel search query pricing solution in a response to the received travel search query.

16. The computer system of claim 15, wherein the other data applicable to the received travel search query includes one or more of air-carrier data, flight data, fare data, and an algorithm.

17. The computer system of claim 15, wherein the accessed data associated with the booking partner specification is based upon an Airline Tariff Publishing Company (ATPCO) category rule.

18. The computer system of claim 15, wherein generated fares are stored as a generated fare containing information about the circumstances under which a particular fare is used.

19. The computer system of claim 18, wherein multiple generated fares are created for the same fare.

20. The computer system of claim 15, wherein the tagged generated fares are used to generate priceable units as part of the travel search query pricing solution.

21. The computer system of claim 15, further operable to calculate taxes and other carrier-imposed surcharges using the required data associated with each applicable booking partner specification used to generate fares.
